(19) United States
(12) Patent Application Publication
(10) Pub. No.: US 2016/0335407 A1
(43) Pub. Date: Nov. 17, 2016

(54) APPARATUS AND METHOD FOR SELECTING HEALTHCARE SERVICES

(71) Applicant: KONINKLIJKE PHILIPS N.V., Eindhoven (NL)

(72) Inventors: Julian Charles NOLAN, Pully (CH); Cees VAN BERKEL, Hove (GB)

(21) Appl. No.: 15/112,519

(22) PCT Filed: Jan. 8, 2015
(86) PCT No.: PCT/EP2015/050187

§ 371 Date: Jul. 19, 2016

(30) Foreign Application Priority Data
Jan. 24, 2014 (EP) 14152493.4

(51) Int. Cl. G06F 19/00; H04L 29/06

(52) U.S. Cl. CPC G06F 19/3418; G06F 19/322; H04L 63/10

(57) ABSTRACT

There is provided an apparatus and method for use in selecting healthcare services for a user, the method comprising: providing (101, 201) a database of health conditions, wherein the database includes symptom information for the health conditions; providing the user with means for monitoring interactions of the user with a network via one or more network-enabled devices; wherein the means for monitoring is configured to detect data which has been input to or generated by the one or more network-enabled devices; monitoring (103, 203), with the means for monitoring, interactions of the user with a network via the one or more network-enabled devices by detecting data input to or generated by the one or more network-enabled devices; analyzing (105, 205) the detected data to determine whether a given interaction includes one or more health-related terms; and if the given interaction is determined to include one or more health-related terms: identifying the one or more health-related terms in the given interaction; determining (107, 207) whether the user may be experiencing one or more of the health conditions in the database by determining whether the identified one or more health-related terms is associated with one or more of the health conditions in the database; establishing (109, 209) which healthcare services are available to the user; and selecting (111, 211) one or more of the available healthcare services based on whether the user may be experiencing one or more of the health conditions.

### TECHNICAL FIELD OF THE INVENTION

The invention relates to an apparatus and method for use in selecting healthcare services, and in particular relates to an apparatus and method for use in selecting appropriate healthcare services for a particular user.

### BACKGROUND TO THE INVENTION

A broad range of devices and associated software are available which utilize telecommunications technologies to deliver health-related services and information. These “telehealth” services allow the diagnosis and support of patients/users in their own home by medical staff located in remote environments. The particular telehealth services provided to a given user are usually prescribed by a healthcare professional based on their assessment of the user's condition(s). This requires significant input from the healthcare professional, usually involves a face-to-face consultation with the user. However; once the user is undergoing telehealth treatment, face-to-face interactions with healthcare professionals occur infrequently. This means that the appropriateness of the particular set of telehealth services being provided to a given user may not be reassessed very often.

It would therefore be desirable to provide a system for automatically recommending and/or selecting appropriate telehealth services, or more generally healthcare services, for a given user from a range of services available, based on the current condition(s) of the user.

### SUMMARY OF THE INVENTION

According to a first aspect of the invention, there is provided a method for use in selecting healthcare services for a user. The method comprises: providing a database of health conditions, wherein the database includes symptom information for the health conditions; providing the user with means for monitoring interactions with a network via one or more network-enabled devices; wherein the means for monitoring is configured to detect data which has been input to and/or generated by the one or more network-enabled devices; monitoring, with the means for monitoring, interactions of the user with a network via the one or more network-enabled devices by detecting data input to and/or generated by the one or more network-enabled devices; analyzing the detected data to determine whether a given interaction includes one or more health-related terms; and if the given interaction is determined to include one or more health-related terms: identifying the one or more health-related terms in the given interaction; assessing whether the user may be experiencing one or more of the health conditions in the database by determining whether the identified one or more health-related terms is associated with one or more of the health conditions in the database; establishing which healthcare services are available to the user; and selecting one or more of the available healthcare services based on whether the user may be experiencing one or more of the health conditions.

In some embodiments the step of providing a database of health conditions comprises selecting health conditions for inclusion in the database based on information about the user. In some such embodiments the selected health conditions are not experienced by the user at the time of the selection, and/or are related to health conditions experienced by the user at the time of the selection.

In some embodiments the method further comprises acquiring current health data for the user, wherein the current health data comprises at least one measured value of one or more physical characteristics of the user. The database may further include information about which symptoms of the health conditions in the database are able to be detected by one or more sensors. The method may further comprise: providing expected values for the one or more physical characteristics of the user; and determining whether a given measured value for a physical characteristic differs from the expected value for that physical characteristic by more than a predefined threshold. The step of assessing whether the user may be experiencing one or more of the health conditions in the database may additionally use the result of the step of determining whether a given measured value for a physical characteristic differs from the expected value for that physical characteristic by more than a predefined threshold. The expected values may be user-specific and be derived based on information about the user. The database may further include symptomatic values for the health conditions in the database, wherein the symptomatic values comprise values of one or more physical characteristics that could be expected to be measured in a user experiencing the condition. In such embodiments the step of assessing whether the user may be experiencing one or more of the health conditions may comprise correlating one or more measured physical characteristic values with the symptomatic values in the database.

In some embodiments the step of assessing whether the user may be experiencing one or more of the health conditions comprises correlating the one or more health-related terms with the symptom information in the database.

There is also provided, according to a second aspect of the invention, a healthcare service selection apparatus. The healthcare service selection apparatus comprises: a memory configured to store a database of health conditions, wherein the database includes symptom information for the health conditions; means for monitoring interactions of the user with a network via one or more network-enabled devices; wherein the means for monitoring is configured to detect data which has been input to and/or generated by the user via the one or more network enabled devices; and a control unit in communication with the means for monitoring and with the memory. The control unit is arranged to analyze data detected by the means for monitoring to determine whether a given interaction of the user with the network via the one or more network-enabled devices includes one or more health-related terms and, if the given interaction is determined to include one or more health-related terms, to: identify one or more health-related terms in the given interaction; assess whether the user may be experiencing one or more of the health conditions in the database by determining whether the one or more health-related terms is associated with one or more of the health conditions in the database; determine which healthcare services are available to the user; and select one or more of the available healthcare services based on whether the user may be experiencing one or more of the health conditions.

In some embodiments the means for monitoring is arranged to monitor information input by the user into a device linked to the network. The means for monitoring may be arranged to monitor data communicated between a device and the network. The device may be one of: a personal computer, a laptop computer, a tablet computer, a smart phone, a mobile phone, a personal digital assistant, a television, a games console, a pill-dispenser, a weight scale. The means for monitoring may comprise a software program or application installed on the network-linked device. For example, the means for monitoring may comprise a keystroke logger or a browser plug-in. Other examples of means for monitoring may comprise an activity monitor, a barcode scanner. Alternatively the means for monitoring may comprise a separate physical apparatus connected to the network-linked device, such as a packet-capture device. The means for monitoring may comprise a camera and/or a microphone.

The healthcare service selection apparatus may further comprise one or more sensors for measuring one or more physical characteristics of the user, wherein the one or more sensors are in communication with the control unit.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 is an illustration of a healthcare service selection apparatus according to a general embodiment of the invention;

FIG. 2 is a flow chart illustrating a method for selecting healthcare services for a user according to a first embodiment of the invention; and

FIG. 3 is a flow chart illustrating a method for selecting healthcare services for a user according to a second embodiment of the invention.

### DETAILED DESCRIPTION OF THE PREFERRED EMBODIMENTS

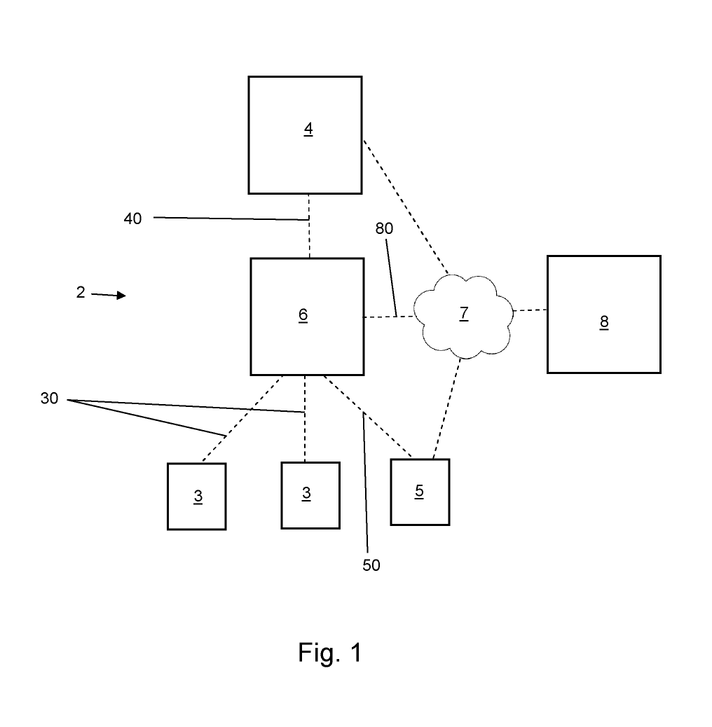

FIG. 1 shows an apparatus for use in selecting healthcare services for a user that can implement the method according to the invention. The apparatus is located in the user's home and may be part of a telehealth apparatus (i.e. an apparatus used to provide telehealth services). The apparatus 2 comprises a control unit 6 that is connected to the user's home computer 4 by a communications link 40. In some embodiments the control unit 6 can also be connected by communications links 30 to one or more sensors 3 for measuring one or more physical or physiological characteristics of the user. In some embodiments the control unit 6 can also be connected by communications links 50 to one or more further network-enabled devices 5 belonging to the user, via which the user can interact with a telecommunications network. The one or more further network-enabled devices may comprise any device capable of communicating with a telecommunications network. Examples of such network-enabled devices include but are not limited to: a laptop computer, a tablet computer, a smart phone, a mobile phone, a personal digital assistant, a television or a games console.

It will be appreciated, therefore, that in some embodiments the one or more further network-enabled devices are configured to receive data input by a user of the device (e.g. by the user entering data with a keypad of the device, or speaking into a microphone of the device) and/or to generate data (e.g. by transforming a signal from a microphone of the device into a text message) and to transmit the input and/or generated data to the network. It will be appreciated that such a network-enabled device may receive data for transmission to the network from a plurality of different input sources. For example, a given network-enabled device (such as a smartphone) may be configured to receive audio data from a microphone of the device and to receive text data from a keypad of the device. Alternatively or additionally, one or more software programs running on the device (such as an SMS messaging application, an e-mail application, a social media application, a web browser, etc.) can generate data which the device subsequently transmits to the network. In this case each software program may be considered to be a source of data. Furthermore, the data input and/or generated need not itself contain content information. Instead, the data input and/or generated could, for example, take the form of the activation of a computer mouse button (i.e. a “click”) in combination with the location of the mouse at the time of the activation. In such a situation, the network interaction might take the form of the user clicking on a weblink or an option in an online form. In such situations data comprised in the clicked-on item is considered to form part of the network interaction. For example, whilst browsing a general health information website the user may click on a link entitled “migraine”. The word “migraine” is then considered to be comprised in the network interaction.

The communications link 40 between the control unit 6 and the computer 4 is preferably wireless, utilizing a protocol such as WiFi, Bluetooth or ZigBee. It will be appreciated, however, that any form of wired or wireless connection which allows data to be communicated between the control unit 6 and the computer 4 may be used. The same applies to the communications link(s) 30 between the control unit 6 and the one or more sensors 3, if present, and to the communications link(s) 50 between the control unit 6 and the one or more further network-enabled devices 5, if present.

In embodiments in which the apparatus 2 comprises at least one sensor 3, each sensor 3 is for measuring one or more physical or physiological characteristics of the user. In some embodiments the apparatus comprises a variety of different sensors 3 so that several different physical characteristics can be measured. One or more of these sensors may be integrated into another device, for example a smartphone belonging to the user. The measured physical characteristics may include, for example, heart rate, heart activity, brain activity, breathing rate, body temperature, blood pressure, movement and location. The sensor 3 may be any device which is capable of measuring a physical or physiological characteristic of the user. The sensor 3 may comprise, for example, an accelerometer, a GPS receiver, a thermometer, a blood pressure monitor, a ventilator, or an ECG, EEG or other electrical sensor. Using the at least one sensor 3, one or more aspects of the user's state over time can be monitored. In preferred embodiments the at least one sensor 3 forms part of a telehealth system.

In some embodiments the apparatus comprises a display and a speaker (not shown) for presenting to the user messages and/or educational multimedia content such as instructional videos for performing particular exercises. In some such embodiments the display and/or speaker are integrated into the same device as the control unit 6. The device may be a telehealth device.

The control unit 6 comprises means (not shown) for monitoring interactions of the user with a telecommunications network 7 via the computer 4 or the one or more further network-enabled devices. In some embodiments the means for monitoring is a software program or application installed on the network-linked device. For example in some embodiments the means for monitoring includes a keystroke logger. Alternatively or additionally, the means for monitoring may include a browser plug-in. Additionally or alternatively, the means for monitoring may include at least one barcode scanner which could be positioned, for example in/on a fridge or a larder or a medicine cupboard. In some embodiments, the means for monitoring may comprise an activity monitor. In other embodiments the means for monitoring may comprise a separate physical apparatus connected to the network-linked device, such as a packet-capture device. In some such embodiments the means for monitoring may include a camera and/or a microphone, to detect movements (such as typing movements) and/or speech of the user.

It will be appreciated that in some embodiments the means for monitoring is configured to detect data input to a network-enabled device at the input stage (e.g. this is the case where the means for monitoring comprises a keystroke logger or a camera arranged to detect typing movements of the user), whereas in other embodiments the means for monitoring is configured to detect data input to or generated by a network-enabled device at the output stage (e.g. this is the case where the means for monitoring comprises a packet-capture device). In still other embodiments (e.g. some embodiments where the means for monitoring is a software program installed on the network-enabled device) the means for monitoring is configured to detect data input to or generated by the network-enabled device during an intermediate processing stage. It will further be appreciated that, in all cases, the means for monitoring is able to detect data which has been input to or generated by a network-enabled device. Furthermore, the means for monitoring is able to detect the data before it is received by the telecommunications network 7. It is therefore the case that what happens to the data after it has been received by the network is irrelevant to the functioning of embodiments of the invention. It follows that the nature, purpose and (if applicable), the intended recipient of a given network interaction is also irrelevant to the functioning of embodiments of the invention.

In some embodiments the telecommunications network 7 is a packet based communications network. The control unit 6 also comprises a communications interface, a memory, and a processing unit (not shown). The communications interface is configured to establish a communications link 80 with a remote central station 8 using a telecommunications network (in the embodiment illustrated in FIG. 1 this is the same network 7 that the user interacts with, however it will be appreciated this need not be the case in all embodiments). The communications link 80 enables the control unit 6 to engage in two-way communication with a remote central station 8. The remote central station 8 may be located, for example, at a healthcare facility or at a dedicated telehealth service provider.

The memory is configured to store data. A database of health conditions and associated symptom information is stored on the memory. The processing unit is linked to the memory such that it can access the data stored in the memory and can save data to the memory. The processing unit is also linked to the communications interface, such that the processing unit can transmit and receive data from the remote central station 8.

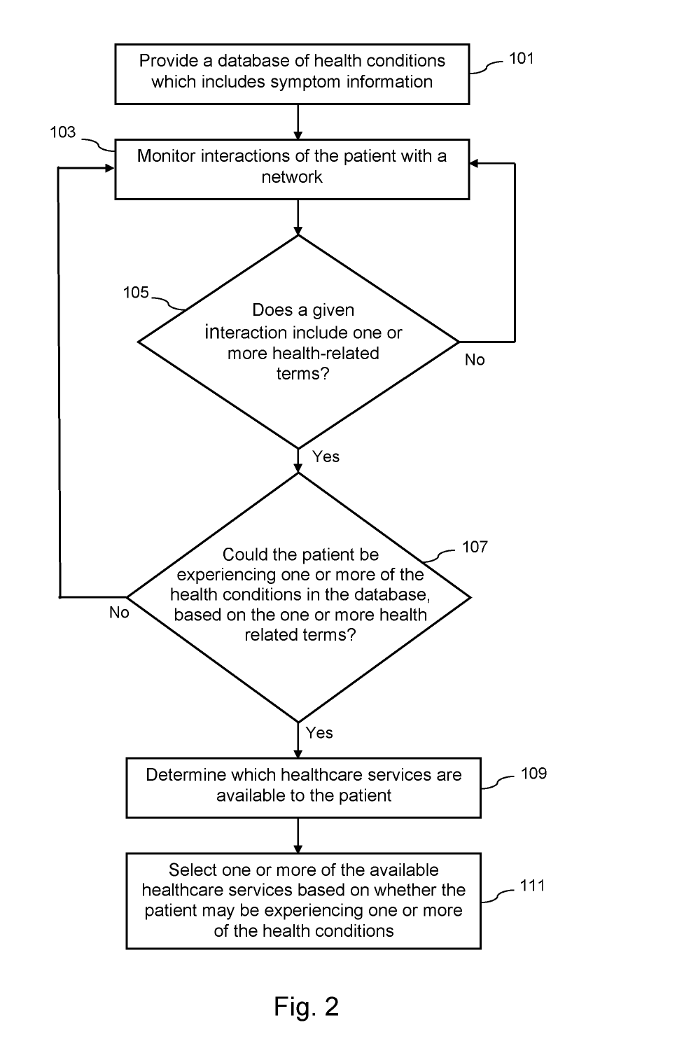

The control unit 6 can implement the healthcare service selection method that is described below and shown in FIG. 2. Alternatively, the control unit 6 can transmit data acquired by the means for monitoring (and the one or more sensors, if present) to the remote central station 8. A processing unit of the remote central station 8 may then implement some of steps in the method shown in FIG. 2.

FIG. 2 shows a method for selecting healthcare services for a user according to a first embodiment of the invention.

In step 101, a database of health conditions is provided. The database includes symptom information for the health conditions. For the purpose of this invention the term “health conditions” also covers “changes in health conditions” and the terms are used interchangeably. For instance a progression from stage I Global Initiative for Obstructive Lung Disease (GOLD) for Chronic Obstructive Pulmonary Disease (COPD) to stage II can either be seen as a new condition or as a change in an existing condition. In some embodiments the symptom information includes terms describing the symptom. Alternatively or additionally, the symptom information may include terms which the user is likely to use in a network interaction (such as an internet search) if they have the symptom in question (such probable search terms may be identified, for example, by mining publically available descriptions of health conditions and their associated symptoms). In preferred embodiments, the database is user-specific (i.e. it includes information which is specific to the particular user, or information which has been selected based on information specific to the particular user). In such embodiments, step 101 involves selecting one or more health conditions for inclusion in the database based on information about the user. The information used in selecting the conditions may include, for example, the user's height, weight, age and/or gender, their current (i.e. at the time of creating and/or updating the database) health status, which conditions they are currently experiencing, their current care plan. In some embodiments the selected health conditions include conditions which the user is not currently experiencing but which are related to conditions which the user is currently experiencing. In some embodiments the selected health conditions include conditions which are related to the treatment the user is receiving (e.g. side effects). In some preferred embodiments the symptom information in the database includes information about which symptoms it is possible to detect using the sensors which are available to the user (e.g. medical sensors already installed in the user's home, or sensors integral with the user's smartphone, etc.). In some embodiments the control unit 6 of the apparatus 2 automatically updates this data in the database based on which devices it is in communication with at a given time. In other embodiments, information about which sensors are available to the user is manually added to the database when the user begins a telehealth care plan, and must be manually updated if, for example, the user is provided with a new type of sensor.

In step 103, interactions of the user with a network are monitored. Preferably the network is a packet-based communications network. The network may be the Internet. Alternatively it could be a local intranet, for example the intranet of a care home at which the user is resident. It will be appreciated that the exact identity and nature of the network is not relevant to the invention. In some embodiments one or more of the network-enabled devices 3 belonging to the user is set-up such that it connects to the network through the control unit 6 (i.e. the control unit 6 receives and forwards data sent to the network by the network-enabled device 3). In such embodiments, data sent to the network from the network-enabled device is analyzed by the processor of the control unit. The data may be copied and stored on the memory of the control unit before being analyzed. Alternatively the analysis may be carried out in real time. In other embodiments, a software application is installed on one or more of the network-enabled devices 3 which records inputs made by the user to the network-enabled device. The software application then periodically sends the input records to the control unit 6 for analysis.

The interaction may take any form. For example, it may comprise a search performed by the user using a search engine. The searchable data may comprise information on the world-wide-web. Alternatively it may comprise other data, which in some embodiments may be customized and/or user specific. Such information may reside, for example, in a care home database which is accessible via an intranet of the care home. In the case the interaction comprises a search; data representing the interaction can include the search terms entered by the user. It may also include the titles, descriptions and/or addresses of links which are clicked on by the user after performing a search (hereinafter referred to as “click-throughs”). The interaction may comprise the user clicking on a link on a website they are browsing. The interaction may comprise the user selecting an option in an online form. In the case the interaction comprises clicking a link or selecting an option; data representing the interaction can include data associated with the selected link or option. For example, such data might include a title, description and/or address of the link or option. Alternatively the interaction may take the form of a post or posts to a social network site, chat room or forum, in which case the data representing the interaction can include the text posted by the user. Alternatively, the interaction may comprise an e-mail sent by the user, in which case the data can include the title and/or main body text of the e-mail. In some embodiments the interaction may be with a telephone network, rather than a data network. In such embodiments, the interaction may take the form of a phone call or a text message. A phone call may be represented by audio data, which can be analyzed to determine the words spoken by the user during the call.

It will be appreciated that in some embodiments, the interaction may take the form of an interactive behavior. As one example, an interactive behavior may be the pattern followed by a user blog or other medium where answers can be provide to specific interrogation or questions of the user. Such a medium can, for example, be of a professional nature, e.g. driven by a health professional, from people suffering from similar conditions. Additionally or alternatively, interactive behavior can also results of video or capsule watched (or being watch) by the user over the network. Additionally or alternatively, such interactive behavior can relate to food behavioral pattern. Alternatively or additionally, it is contemplated that interactive behavior (or interaction) may relate to medication intake behavioral.

It will further be appreciated that, since the monitoring takes place at the user-end (i.e. the means for monitoring detects data comprised in network interactions before that data is received by the network), factors relating to what happens to the data after it is received by the network (such as the intended purpose, nature and (if applicable) recipient of an interaction) are not relevant to the functioning of the invention.

In some embodiments, certain predefined criteria must be met before further analysis is undertaken in respect of a given interaction. For example, the memory of the control unit 6 may store criteria defining trigger events. In such embodiments, the monitored interactions are continually analyzed by the control unit 6 to detect trigger events meeting the criteria. A trigger event may comprise, for example, the user reaching a predefined minimum number of click-throughs after performing a search. Alternatively, a trigger event may comprise the user performing a minimum number of searches within a certain time period. Preferably trigger events are defined such that a certain intensity of interaction activity is required before further analysis is undertaken in respect of that activity. Advantageously, defining such trigger events can avoid unnecessary analysis being performed in respect of interactions which are very unlikely to yield useful information about the user's health. In step 105, it is determined whether a given interaction includes one or more health-related terms. A health-related term can be a single word having some relevance to a health condition. For example, the word “itch” is a health-related term because it refers to a phenomenon which is a symptom of several health conditions (such as eczema). A health-related term may also be a specific combination of multiple words, where the combination has some relevance to a health condition. For example the term “yellow fever” is a specific combination of the words “yellow” and “fever” which is a health-related term because it refers to a particular health condition. (It will be appreciated that the individual term “fever” is also a health-related term since when this word is used alone it refers to a symptom. For the purposes of the invention, a health-related term may comprise an entry on a list of health-related terms which is accessible by the control unit 6. Such a list may be provided, for example, in the memory of the control unit 6 or in the memory of the remote central station 8. By way of example, the list of health-related may include (but is not limited to) any or all of the following terms: “itch”; “eczema”; “fever”; “yellow fever”; “temperature”; “high temperature”; “nausea”; “vomiting”; “rash”; “itchy rash”; “swelling”; “swollen joints”; “redness”; “dry mouth”; “cough”; “chesty cough”; etc.

In preferred embodiments the determination of step 105 is carried out by the processing unit of the control unit 6 (however; in other embodiments it may be carried out by a remote server). The processing unit receives data representing the interaction (for example in the form of data packets sent to the network by one of the network-enabled devices 3, or input data recorded by a software application installed on one of the network-enabled devices 3 (such as an application running on a tablet computer)). The processing unit then analyses this data to identify whether it contains any health-related terms.

In some embodiments this analysis involves identifying health-related terms in an interaction (for non-text based interactions such as phone calls, this may require an additional initial step of producing a text version of the interaction, using any suitable techniques known in the art). In some embodiments this identification is performed using text-mining and/or other semantic computing techniques . . . . For example, the terms in the interaction may be compared with a list of health-related terms provided in the memory of the control-unit. In preferred embodiments, the analysis involves using morphological analysis to identify and compare morphological variants (i.e. the terms itch, itching, itchiness and itchy are all morphological variants of each other) of each term in the interaction and in the list of health-related terms. In some such embodiments, terms which are morphological variants of each other are considered to match. In some embodiments, the analysis also involves identifying synonyms of identified health-related terms using a look-up table provided in the memory of the control unit 6.

In some alternative embodiments the list of health-related terms and/or the look-up table is provided in a memory remote from the control unit 6, for example a memory of the remote central station 8, in which case performing step 105 involves the control unit 6 communicating with the remote memory. In still other alternative embodiments the data representing the interaction is sent by the control unit 6 to the remote central station 8 and a processing unit of the remote central station 8 performs step 105. Alternatively, step 105 may be performed by a processor of the user's computer 4.

The aim of the monitoring is to understand areas of special interest to the user, and to determine whether these are of relevance to their care plan. Thus if a given interaction is found to include one or more health-related terms, in step 107 a determination is made as to whether the user could be experiencing one or more of the health conditions in the database, based on the one or more health-related terms identified in the interaction (and, if applicable, their synonyms). In some embodiments the determination as to whether the user could be experiencing one or more of the health conditions in the database involves correlating the one or more health-related terms (and, if applicable, their synonyms) with the symptom information in the database. This correlating may comprise, for example, counting the number of matching terms for each health condition. In some embodiments the identified health-related terms (and, where applicable, their synonyms) are alternatively or additionally correlated with symptom information for health conditions the user is already known to be experiencing, which is provided as a database of existing health conditions in the memory of the control unit 6. Preferably morphological variants are taken account of, as described above, when performing the correlation(s).

The results of the correlating are used to determine whether the user could be experiencing one or more of the health conditions or changes in existing health conditions in the database. For example, if the interaction was found to contain the terms “rash” and “itching”, and the database includes the condition eczema along with the information that an itchy rash is a symptom of eczema, then two terms from the interaction match the condition eczema. It will therefore be determined that the user could be experiencing eczema. Preferably this determination is performed for each of the health conditions or changes in health conditions in the database. In some embodiments this calculation is additionally performed for health conditions the user is known to be already experiencing, using the database of existing health conditions.

A degree of likelihood that the user is experiencing one or more of the health conditions or changes in existing health conditions in the database(s) may be calculated based on the strength of the correlation. Alternatively or additionally it may be based on other factors such as, for example, the rarity of the condition, whether the user is known to have any factors which predispose them to the condition, and/or whether it is a known side effect of the treatment they are currently undergoing. Where the identified health-related terms (and, if applicable, their synonyms) match more than one health condition, in some embodiments a scoring system is used to determine which health condition is the best fit and or to determine the relative likelihood of the matching health conditions. For example, a condition which matches two of the identified health-related terms (and/or synonyms) from a given interaction will be assigned a higher score (and/or a higher likelihood) than a condition which matches only one term from that interaction. Alternatively or additionally, factors such as the relative order or proximity to each other of the health-related terms in the interaction and in the symptom information may be taken into account when assigning a score/likelihood.

In some embodiments a ranked list of the health conditions the user may be experiencing is produced. This may be based on the strength of the correlation for each health condition. Alternatively or additionally, it may be based on other factors, such as those listed above. In some embodiments the assigned scores and/or likelihoods are used to produce a ranked list. In preferred embodiments step 107 is carried out by the processing unit of the control unit 6. However; in other embodiments step 107 may be carried out away from the control unit 6, for example by a processor of the remote central station 8, or by a processor of the user's computer 4.

If it is found in step 107 that the user could be experiencing one or more of the health conditions in the database, in step 109 a determination is made as to which healthcare services are available to the user. The health care services could include, for example, any or all of: the provision (or activation) of additional monitoring modalities (such as a fall detector if it is determined that the user is experiencing balance problems); cholesterol monitoring if the user is at increased risk of a myocardial infarction; the provision (or activation) of a spirometer for users with COPD; the provision of medication dispensers if a user becomes non-compliant, the provision of additional health information or coaching programs (for example, delivered through control unit 6 or the user's computer 4) if a user becomes inactive, computerized cognitive behavior therapy (CBT) if a user has become, or is at risk of becoming, depressed; registering the user with a local meals-on-wheels service if the user has become poorly nourished; registering the user with befriending services if they have become socially isolated; registering the user with home care services if they are suffering from self neglect; provision of counseling services if the user has experienced a difficult life event.

The healthcare services available to the user may include healthcare services which are already being provided to them. In such cases it may be desirable to alter one or more parameters of the healthcare service already being provided. For example, for a user who is being monitored in respect of one or more physical characteristics, it may be desirable to change the frequency of the measurements of one or more of those physical characteristics. Alternatively or additionally, it may be desirable to change a user's existing alert thresholds.

In some embodiments the determination of which healthcare services are available to the user may be based on a database of healthcare services stored in the memory of the control unit. In such embodiments, the database may contain information relating to, for example, healthcare services located near the user (e.g. telehealth services provided by the apparatus 2), services which are offered by the user's current telehealth provider, or services which form part of the user's current care plan Additionally or alternatively, the determination may involve sending a query to the remote central station to determine which healthcare services are currently available. Where a particular service is time dependent (for example a phone call or consultation with a healthcare professional may only be available during working hours), this information may be taken into account in the determination. In preferred embodiments step 109 is carried out by the processing unit of the control unit 6. However; in other embodiments step 109 may be carried out away from the control unit 6, for example by a processor of the remote central station 8, or by a processor of the user's computer 4.

In step 111, one or more of the available healthcare services are selected. The selection is based on the suitability of a given healthcare service for addressing the one or more conditions which it has been determined that the user may be experiencing. In some embodiments a database of healthcare services is provided (for example in the memory of the control unit 6 or in a memory of the remote central station 8) for use in the suitability determination. The database of healthcare services may, for example, link each service with attributes of that service, and/or suitability information with respect to various health conditions, and/or availability information. Alternatively or additionally, information regarding the suitability and/or availability of various healthcare services may be provided in the database of health conditions, for the health conditions and/or symptoms in the database.

In some embodiments, the selecting involves generating a ranked list of the available healthcare services. The position of a given healthcare service in the list may depend on factors such as the degree of its suitability for addressing one or more of the possible health conditions and the degree of likelihood that the user is experiencing the possible health conditions for which it is suitable. In preferred embodiments step 111 is carried out by the processing unit of the control unit 6. However; in other embodiments step 111 may be carried out away from the control unit 6, for example by a processor of the remote central station 8, or by a processor of the user's computer 4.

In some embodiments the result of the selecting is displayed to the user. Alternatively or additionally, the result of the selecting may be sent to the user's healthcare provider. In some embodiments the result of the selecting is used to automatically update the user's care plan, for example by scheduling (or bringing forward) a telephone call or visit from a healthcare professional. In embodiments where the result of the selecting comprises a ranked list of the available healthcare services, one or more of the highest ranked healthcare services may automatically be initiated and/or added to the user's care plan.

If in step 107 or step 105 it is determined that the user could not be experiencing any of the health conditions in the database, or that the given interaction does not include any health-related terms, respectively, then the method returns to step 103 (i.e. the apparatus continues to monitor the user's interactions with the network).

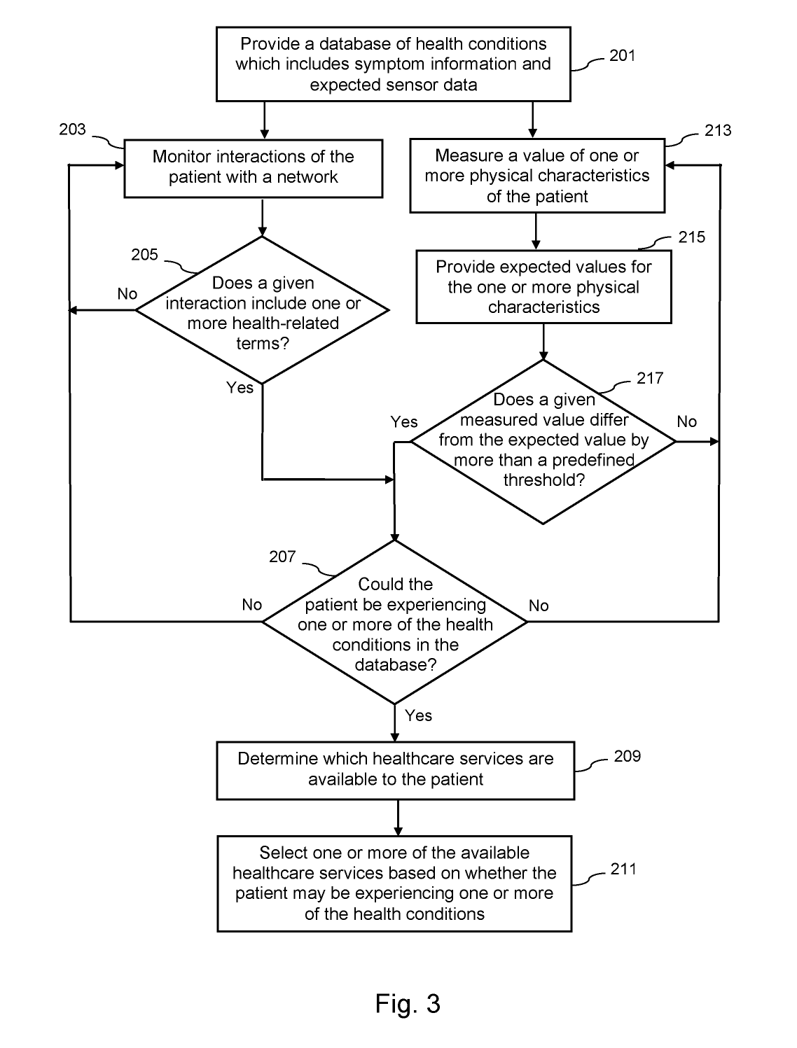

FIG. 3 shows a method for selecting healthcare services for a user according to a second embodiment of the invention. Steps 203, 205, 209 and 211 are the same as steps 103, 105, 109 and 111 respectively of the FIG. 2 method and will therefore not be described again.

In step 201, a database of health conditions is provided. As with the database provided in step 101 of the method of FIG. 2, the database includes symptom information for the health conditions. However; the database provided in step 201 additionally includes “symptomatic values”. These symptomatic values comprise expected sensor data for each of the health conditions in the database (i.e. the values of various physical characteristics that would be expected to be measured in a user experiencing that condition). In this embodiment the apparatus 2 comprises at least one sensor 3, and preferably the symptomatic values in the database correspond to physical characteristics that can be measured using the sensor 3. In preferred embodiments, the database is user-specific. This may be achieved as described above in relation to step 101 of FIG. 2. Alternatively or additionally, the symptomatic values in the database may be derived based on information about the user. For example, if a symptom of a given health condition in the database is weight loss, in some embodiments the symptomatic values relating to body weight associated with this health condition will be calculated using the current weight of the user and the expected effect on body weight of the health conditions they are known to be experiencing and the treatments they are receiving.

In steps 203 and 205, interactions of the user with the network are monitored and analyzed to determine whether they contain any health-related terms as described above in relation to steps 103 and 105 of FIG. 2. Steps 213 and 215 may be performed in parallel with this monitoring of user network interactions.

In step 213, a value of one or more physical or physiological characteristics of the user is measured. In preferred embodiments this measurement is carried out by the sensor 3. The measurement data acquired by the sensor 3 is then communicated to the control unit 6. In some embodiments this communication occurs whenever a new measurement is acquired. In alternative embodiments the sensor 3 is configured to communicate the most recently acquired measurements to the control unit 6 at predefined time intervals. In some embodiments the control unit 6 stores the received measurement data in a database in its memory.

In step 215 a time variant set of expected values for one or more physical or physiological characteristics of the user is provided. In preferred embodiments this set of expected values is stored in the memory of the control unit 6. Preferably the physical characteristics for which expected values are provided include or are the same as the physical characteristics measured by the sensors 3. The expected values are values of the physical characteristics which may be expected under normal conditions over the course of the user's care plan. In some embodiments the expected values are derived by calculating the effect the user's underlying health condition and the treatment they are receiving can be expected to have over time on their physical characteristics.

In step 217 the control unit 6 (using its processing unit) compares a received measured value to the expected value for that characteristic at the time the measured value was acquired (hereafter referred to as the “corresponding expected value”) to determine whether the measured value deviates from the corresponding expected value by more than a predefined deviation threshold. The predefined deviation threshold is programmed into the memory of the control unit 6. In some embodiments the predefined threshold is a default value which is set during the manufacture or initial set-up of the apparatus 2. In such embodiments the predefined deviation threshold may be set in dependence on the physical characteristic to which it relates, and/or other general considerations. In alternative embodiments the predefined deviation threshold is user-specific. In some such embodiments the predefined deviation threshold is defined by a medical professional based on information about the user.

If it is determined in step 217 that the deviation of the received measured value from the corresponding expected value is greater than the predefined threshold, in some embodiments this triggers the control unit 6 to determine (in step 207) whether the user could be experiencing one or more of the health conditions in the database, based on one or more of the measured physical characteristic values. In some embodiments the determination as to whether the user could be experiencing one or more of the health conditions in the database involves correlating the one or more measured physical characteristic values with the symptomatic values in the database of health conditions. Preferably the correlating involves normalizing the measured values and the values in the database. The normalized values may then be compared to each other. In some embodiments a tolerance is defined (e.g. in the memory of the control unit 6), such that a measured value which differs from a corresponding value in the database by less than a predefined tolerance threshold is deemed to match the value in the database. In some such embodiments, one or more general tolerance thresholds are defined, each of which applies to multiple health conditions. In other embodiments a tolerance threshold is defined for each individual health condition.

In some embodiments, the correlation is performed on the basis of just the most recently acquired measured value. In other embodiments the set of measured values of a predefined size immediately preceding the most recent measured value is used in the correlating. In still other embodiments, a number of consecutive measured values are required to have deviated from the expected values by more than the predefined deviation threshold before the performance of step 207 is triggered. In some such embodiments the correlation is performed on the basis of the set of measured values which deviate by more than the deviation threshold.

The results of the correlating are then used to determine a likelihood that the user is experiencing one or more of the health conditions in the database, as described above in relation to step 107 of FIG. 2. If a recent user network interaction has been determined in step 205 to include one or more health-related terms, then the one or more health-related terms are correlated with symptom information in the database and the results of this correlating are also used in the determination of the likelihood that the user is experiencing one or more of the health conditions in the database. In some embodiments a predefined time period is provided (e.g. in the memory of the control unit 6), such that correlation results relating to user network interactions occurring within this predefined time period are considered in the determination, whereas correlation results relating to user network interactions occurring outside the predefined time period are not considered. In some embodiments the predefined time period is fixed. The predefined time period may be, for example, 24 hours prior to the time at which the received measured value was measured. In some embodiments the predefined time period is user-specific and is defined based on, for example, the age and/or existing health condition(s) of the user.

If it is found in step 207 that the user could be experiencing one or more of the health conditions in the database, then steps 209 and 211 are performed in the same manner as steps 109 and 111 described above. In some embodiments the measured physical characteristic values are taken into account in the performance of step 111.

If in step 207 or step 217 it is determined that the user could not be experiencing any of the health conditions in the database, or that the given measured value does not differ from the corresponding expected value by more than the predefined threshold, respectively, then the method returns to step 213 (i.e. the apparatus continues to monitor one or more of the user's physical characteristics using the sensor 3).

In the foregoing description all of the steps of the method of FIG. 3 are carried out by the apparatus 2. However, it will be appreciated that some or all of the steps performed by the processing unit of the control unit 6 could alternatively be performed by a processing unit of the remote central station 8, or a processing unit of the user's computer 4. In such embodiments the method will include the additional steps of communicating the data to be processed to the remote central station 8 or to the user's computer 4.

The selection of one or more healthcare services generated by step 111/211 may be communicated to the user and/or the healthcare professional responsible for the user's care plan and/or friends or family members of the user by any suitable means. Alternatively or additionally, the control unit 6 may alter the scheduling of the user's healthcare services. For example, if at step 107/207 it is determined that the user could be experiencing a potentially serious health condition, a face-to-face appointment with a healthcare professional may be arranged or an existing appointment brought-forward. In some embodiments this scheduling is performed automatically by the control unit 6, in communication with the remote central station 8. In other embodiments the control unit 6 generates a recommendation to the user to perform the rescheduling.

In some embodiments of the invention, following the performance of step 111/211 the control unit 6 automatically performs an internet search using the health-related terms identified in the user network interaction as well as keywords associated with the one or more health conditions the user may be experiencing, as determined in step 107/207. In such embodiments, suitable keywords for each condition may be listed in the database of health conditions. The results of this automatic search are then provided to the user. In some embodiments this is achieved by a pop-up window appearing on the display of whichever network-enabled device was used for the user's most recent network interaction. Alternatively or additionally, the results of the automatic search may be sent to the user in an e-mail.

In some embodiments of the invention, following the performance of step 111/211 the control unit 6 determines which healthcare services the user is likely to need in the future. In such embodiments the control unit 6 has access to historical user data. The historical user data may, for example, be stored in the memory of control unit 6. Alternatively the historical user data may be stored on the remote central station 8, such that the control unit 6 must use the communications link 80 to access the data. In these embodiments the control unit 6 compares recent measured physical characteristic values and/or health-related terms identified in recent user network interactions to the historical data to identify matching contextual situations. The control unit 6 then uses the historical data (e.g. information about how the historical situation developed and what treatment was administered in that situation) to predict the future healthcare needs of the user. In some embodiments this prediction is presented to the user and/or to the healthcare professional responsible for the user's care plan. In some embodiments the control unit 6 uses the prediction to schedule healthcare services for the user. Alternatively or additionally the prediction is used to update the selection of available healthcare services generated in step 111/211.

Methods according to embodiments of the invention therefore allow healthcare services, and particularly telehealth services, to be scheduled with improved efficiency. This results in cost savings for the healthcare service provider and a higher level of service for the user. Furthermore, because such methods enable the continual reassessment of the appropriateness of the healthcare services being provided to a particular user, the provision of such services can be optimized and adapted to address changes in the user's condition over the course of a care plan. This results in improved treatment outcomes. A further related benefit is that new conditions or the worsening of existing conditions can be recognized at an early stage, before they become serious. This means that the necessary treatment can be commenced earlier, with consequent improved outcomes. At the same time, the burden on healthcare professionals is reduced because automated systems are used, and the data to be input into these automated systems is generated by the users themselves.

Although the invention has been described above as being preferably for use in conjunction with telehealth systems, it will be appreciated that the invention can be used to assist in the selection of appropriate healthcare services of any type, in any situation where the user has access to a network enabled device.

While the invention has been illustrated and described in detail in the drawings and foregoing description, such illustration and description are to be considered illustrative or exemplary and not restrictive; the invention is not limited to the disclosed embodiments.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method for use in selecting healthcare services for a user, the method comprising:
providing a database of health conditions, wherein the database includes symptom information for the health conditions;
providing the user with means for monitoring interactions with a network via one or more network-enabled devices; wherein the means for monitoring is configured to detect data which has been input to and/or generated by the user via the one or more network-enabled devices;
monitoring, with the means for monitoring, interactions of the user with a network via the one or more network-enabled devices by detecting data input to and/or generated by the user via the one or more network-enabled devices;
analyzing the detected data to determine whether a given interaction includes one or more health-related terms; and
if the given interaction is determined to include one or more health-related terms:
identifying the one or more health-related terms in the given interaction;
assessing whether the user may be experiencing one or more of the health conditions in the database by determining whether the identified one or more health-related terms is associated with one or more of the health conditions in the database;
establishing which healthcare services are available to the user; and
selecting one or more of the available healthcare services based on whether the user may be experiencing one or more of the health conditions.

2. The method of claim 1, wherein the step of providing a database of health conditions comprises selecting health conditions for inclusion in the database based on information about the user.

3. The method of claim 2, wherein the selected health conditions are not experienced by the user at the time of the selection, and/or are related to health conditions experienced by the user at the time of the selection.

4. The method of claim 1, further comprising acquiring current health data for the user, wherein the current health data comprises at least one measured value of one or more physical characteristics of the user.

5. The method of claim 4, wherein the database further includes information about which symptoms of the health conditions in the database are able to be detected by one or more sensors.

6. The method of claim 4, further comprising:
providing expected values for the one or more physical characteristics of the user; and
determining whether a given measured value for a physical characteristic differs from the expected value for that physical characteristic by more than a predefined threshold.

7. The method of claim 6, wherein the step of assessing whether the user may be experiencing one or more of the health conditions in the database additionally uses the result of the step of determining whether a given measured value for a physical characteristic differs from the expected value for that physical characteristic by more than a predefined threshold.

8. The method of claim 6, wherein the expected values are user-specific and are derived based on information about the user.

9. The method of claim 6, wherein:
the database further includes symptomatic values for the health conditions in the database, wherein the symptomatic values comprise values of one or more physical characteristics that could be expected to be measured in a user experiencing the condition; and
wherein the step of assessing whether the user may be experiencing one or more of the health conditions comprises correlating one or more measured physical characteristic values with the symptomatic values in the database.

10. The method of any preceding claim, wherein the step of assessing whether the user may be experiencing one or more of the health conditions comprises correlating the one or more health-related terms with the symptom information in the database.

11. A healthcare service selection apparatus comprising:
means to access a database of health conditions, wherein the database includes symptom information for the health conditions;
means for monitoring interactions of the user with a network via one or more network-enabled devices; wherein the means for monitoring is configured to detect data which has been input to and/or generated by the user via the one or more network enabled devices;
a control unit in communication with the means for monitoring and with the memory, wherein the control unit is arranged to:
analyze data detected by the means for monitoring to determine whether a given interaction of the user with the network via the one or more network-enabled devices includes one or more health-related terms; and
if the given interaction is determined to include one or more health-related terms:
identify the one or more health-related terms in the given interaction;
assess whether the user may be experiencing one or more of the health conditions in the database by determining whether the one or more health-related terms is associated with one or more of the health conditions in the database;
establish which healthcare services are available to the user; and
select one or more of the available healthcare services based on whether the user may be experiencing one or more of the health conditions.

12. The healthcare service selection apparatus of claim 11, wherein the means for monitoring is arranged to monitor information input by the user into a device linked to the network.

13. The healthcare service selection apparatus of claim 11, wherein the means for monitoring is arranged to monitor data communicated between a device and the network.

14. The healthcare service selection apparatus of claim 12, wherein the device is one of: a personal computer, a laptop computer, a tablet computer, a smart phone, a mobile phone, a personal digital assistant, a television, a games console.

15. The healthcare service selection apparatus of claim 11, further comprising one or more sensors for measuring one or more physical characteristics of the user, wherein the one or more sensors are in communication with the control unit.
